(19) United States
(12) Patent Application Publication
(10) Pub. No.: US 2024/0261703 A1
(43) Pub. Date: Aug. 8, 2024

(54) CHROMATOGRAPHIC DEVICE

(71) Applicant: JSR CORPORATION, Minato-ku (JP)

(72) Inventors: Daniel M. BAILEY, Greenland, NH (US); Steven R. PEARL, Nashua, NH (US); Guido STROEHLEIN, Hassendorf (DE)

(73) Assignee: JSR CORPORATION, Minato-ku (JP)

(21) Appl. No.: 18/566,826

(22) PCT Filed: Jun. 23, 2022
(86) PCT No.: PCT/US2022/034716

§ 371 Date: Dec. 4, 2023

Related U.S. Application Data
(60) Provisional application No. 63/214,358, filed on Jun. 24, 2021.

(51) Int. Cl. B01D 15/14; B01D 15/18; B01D 15/22

(52) U.S. Cl. CPC B01D 15/14; B01D 15/1871; B01D 15/22

(57) ABSTRACT

A chromatographic device, including a housing including an inlet and an outlet of a fluid, an inlet distribution plate positioned inside the housing such that the inlet distribution plate receives a fluid flowing through the inlet and distributes the flow inside the housing, an inlet frit plate positioned on the inlet distribution plate, a chromatography medium placed inside the housing, at least one multi-planar screen positioned inside the housing to receive the fluid to be separated from the inlet distribution plate and the inlet frit plate, the multi-planar screen being structured such that the chromatography medium is held inside thereof, and that the fluid to be separated from the inlet distribution plate and the inlet frit plate passes through the chromatography medium, an outlet distribution plate that receives the fluid separated, and an outlet frit plate positioned on the outlet distribution plate such that the outlet frit plate receives a force created by the flow of the fluid through the chromatography medium.

### CROSS-REFERENCE TO RELATED APPLICATIONS

The present application claims the benefits of priority to U.S. Provisional Application 63/214,358, filed Jun. 24, 2021, whose entire contents are incorporated herein by reference.

### FIELD OF THE INVENTION

The present invention relates to a chromatographic device, and more particularly to a chromatographic device or a system that may be used in a series of modules or cassettes. The present invention also relates to a method of separating components in a fluid by using such a chromatographic device or system.

### BACKGROUND OF THE INVENTION

Chromatography is used in a wide variety of industries in which one or more solutes, being transported by one or more fluids, are separated or resolved in a chromatographic medium such as a resin or media having adsorptive properties in order to separate the solutes.

Chromatographic columns are often employed in such chromatography. Such columns are easy to fabricate, convenient to use, and multiple columns may be used in sequence. In general, adsorptive media is packed into the column, for example as beads, and a mobile liquid phase is pumped through the column. The various components in the liquid phase interact with the packed media. The interaction between the liquid phase and the media results in a physical separation of the components into component solutes. The separated components may be collected or detected at the outlet end of the single column or the outlet end of the last column in a series of columns.

Exemplary chromatographic techniques may include techniques such as ion exchange chromatography, hydrophobic interaction chromatography, gel chromatography, reversed phase chromatography, ion affinity chromatography and the like. Exemplary chromatographic devices are provided, for example, in U.S. Pat. Nos. 7,390,408; 8,506,802; 9,120,037; 9,599,594; and 9,943,781, the disclosures of which are incorporated by reference in their entirety. These chromatographic devices, however, have inherent limitations such as non-equal flow distribution, high pressure drop required, media compression, difficulties in packing, major challenges in their manufacturing, etc. A goal for chromatographic devices is to overcome those limitations and to maintain the flow path substantially the same for every molecule. Another goal is for a device that may be stacked or provided as a series of modules while still avoiding the above inherent limitations.

### SUMMARY OF THE INVENTION

According to an aspect of the present invention, a chromatographic device includes a housing including an inlet and an outlet of a fluid, an inlet distribution plate positioned inside the housing such that the inlet distribution plate receives the fluid flowing through the inlet and distributes a flow inside the housing, an inlet frit plate positioned on the inlet distribution plate, a chromatography medium placed inside the housing, at least one multi-planar screen positioned inside the housing to receive the fluid to be separated from the inlet distribution plate and the inlet frit plate, the multi-planar screen being structured such that the chromatography medium is held inside thereof, and that the fluid to be separated from the inlet distribution plate and the inlet frit plate passes through the chromatography medium, an outlet distribution plate that receives the fluid separated, and an outlet frit plate positioned on the outlet distribution plate such that the outlet frit plate receives a force created by the flow of the fluid through the chromatography medium.

According to another aspect of the present invention, a chromatographic device includes a housing including an inlet of a fluid and an outlet of the fluid and having plural side walls, an inlet distribution plate positioned inside the housing, an inlet frit plate positioned on the inlet distribution plate and structured to distribute a flow of the fluid, a chromatography medium supported in the housing and positioned to receive the fluid to be separated from the inlet distribution plate and the inlet frit plate, and an outlet distribution plate positioned inside the housing and configured to direct the fluid to the outlet, and an outlet frit plate positioned on the outlet distribution plate to receive a force of the flow of the fluid through the chromatography medium. The inlet frit plate, the outlet frit plate, and the sidewalls enclose the chromatography medium such that the chromatography medium is held in place.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A shows an exploded perspective view of a chromatographic device according to at least one embodiment of the invention.

FIG. 1B is an illustration showing the directions of the flow of the fluid and the directions of the force created by the flow of the fluid inside the housing of the chromatographic device.

FIG. 1C is an illustration showing the directions of the flow of the fluid inside the housing of the chromatographic device.

FIG. 2A shows a perspective view of the chromatographic device shown in FIG. 1A in assembled form.

FIG. 2B shows a perspective view of a housing of an alternative design.

FIG. 3A is an exploded perspective view of a distribution plate and frit plate of the chromatographic device.

FIG. 3B is an illustration of a pattern in an inlet/outlet distribution plate.

FIG. 3C is an illustration of another pattern in the inlet/outlet distribution plate.

FIG. 4 is a perspective view with connectors for joining multiple chromatographic devices in series.

FIG. 5A is a perspective view with connectors for joining multiple chromatographic devices in series with connection brackets included.

FIG. 5B is a perspective view with connectors for joining multiple chromatographic devices in series with connection brackets included.

FIG. 6 is a blown up perspective view of the connection bracket shown in FIG. 5A.

FIG. 7 is a perspective view of a series of connected chromatographic devices to provide a chromatography system in a holder.

FIG. 8A is a perspective view of the chromatography system of FIG. 7 in a holder.

FIG. 8B is another perspective view of the chromatography system of FIG. 7 in a holder, showing flow directions.

FIG. 8C is another perspective view of the chromatography system of FIG. 7 in a holder, showing flow directions in and between the devices connected in parallel.

FIG. 9 is a perspective view of an exemplary bi-planar screen.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

All patents, patent applications and publications referred to herein are incorporated by reference in their entirety. In case of a conflict in terminology, the present specification is controlling.

A chromatographic device in which various fluid components are resolved by the use of chromatographic medium is presented. The device may include a housing having an upper portion that includes a fluid inlet, a lower portion that includes a fluid outlet, and a central portion disposed between the upper and lower portions. The housing may include an inlet distribution plate and an inlet frit plate to distribute flow of the fluids, including the solutes to be separated, wherein the inlet distribution plate and the inlet frit plate may be disposed in the upper portion of the housing. The housing may further include a chromatography packing medium or resin provided on a multi-planar screen support structure positioned in the central portion of the housing to receive the fluid to be separated from the inlet distribution plate and the inlet frit plate, wherein the fluids may flow through the chromatography packing medium in an upward or downward direction. The housing may also include an outlet distribution plate and an outlet frit plate for receiving the fluids and distributing the fluids to the fluid outlet, wherein the outlet distribution plate and the outlet frit plate may be disposed in the lower portion of the housing. The inlet and outlet frit plates, the two sidewalls and the top and bottom plate may retain the chromatography packing medium in place and the outlet frit plate may bear the force of the fluid through the chromatography packing medium.

Multiple chromatographic devices may be linked or connected together and a rigid housing or holder may be used for one or several chromatographic device to provide a chromatography system or assembly. Due to the scalability and ease of use, the chromatographic device of the present disclosure may allow for high purification productivity and may be designed for single-use, rapid cycling and/or continuous processing.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

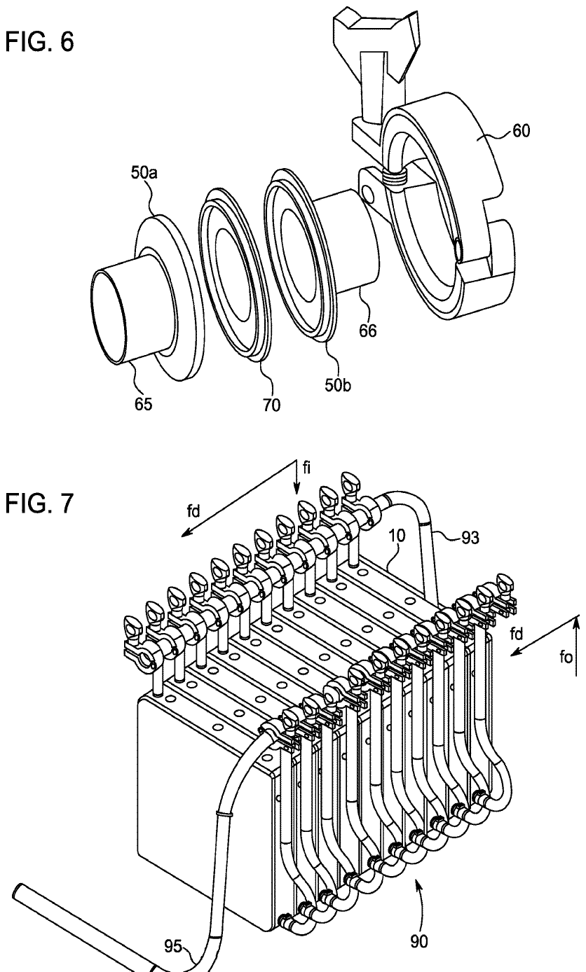

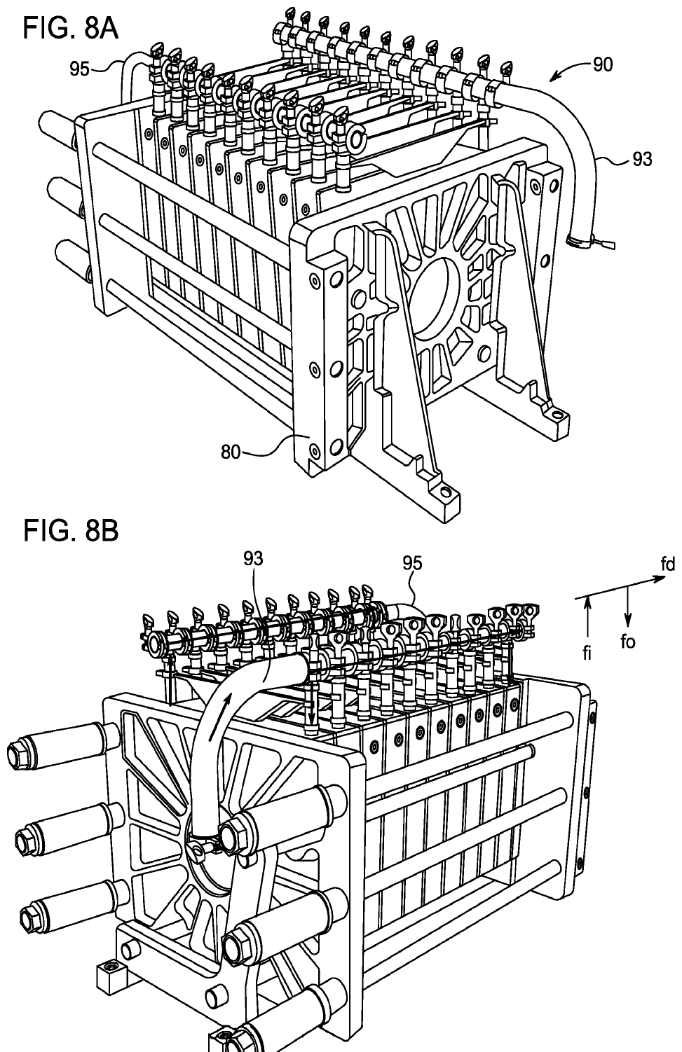

As shown in the Figures, the present disclosure provides exemplary embodiments of a chromatographic device 10 that may include a modular construction which may be stackable and may be pre-packed with chromatographic resin. The chromatographic device 10 of the present disclosure can allow for higher flow rates (lower residence times) with a wide variety of resins or medium having varying chemistries, particle size and ligands, typically with excellent capacity and selectivity properties. For example, the residence time that can be achieved by the embodiments of the present application may be in the range of 0.1-20 min, 0.3-5 min, or 0.5-3 min. The design of the chromatographic device provides flexible scaling and meets process capacity requirements while allowing bed heights from about 5 to 50 cm, preferentially from about 5 to 20 cm, more preferentially from about 6 to 20 cm. In an embodiment, multiple chromatographic devices 10 having substantially the same size and shape may be combined together to provide an assembly of devices, such as a chromatography system 90 shown in FIGS. 7 and 8A-8C.

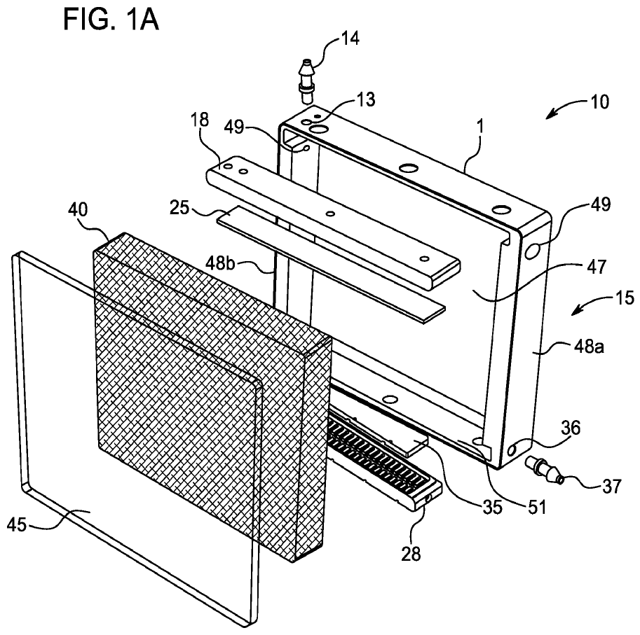

Referring to FIG. 1A, the exemplary chromatographic device 10 may include a housing 15 having upper, central and lower portions. In the upper portion, the housing 15 may include a fluid inlet 13, inlet fitting 14, an inlet distribution plate 18, and an inlet frit plate 25. In the lower portion, the housing 15 may include an outlet distribution plate 28, an outlet frit plate 35, a fluid outlet 36, and outlet fitting 37.

FIG. 1B and FIG. 1C illustrate the directions of the flow of a fluid or a liquid inside the housing 15 of the chromatographic device 10.

In an embodiment, the inlet distribution plate 18 can be structured to distribute the fluid evenly or substantially evenly so that the fluid flow rate at any point of the inlet frit plate surface towards the packed bed is the same or substantially the same. As an alternative, a structure with multiple parallel channels or a wide center channel containing support pins for the inlet frit plate can be utilized.

In an embodiment, the inlet frit plate 25 can be structured to provide the following functions. One is to further promote an even distribution or substantially even distribution of the fluid so that the fluid flow rate at any point of the inlet frit plate surface towards the packed bed is the same or substantially the same, Another function is to provide a structure where the fluid and the solutes are permeable or substantially permeable, whereas the beads of the chromatographic media are impermeable or substantially impermeable. Another function is to provide sufficient or desired mechanical rigidity to bear the force of the screens or at least a significant or major portion of the force caused by the fluid flow.

In an embodiment, the housing 15 may be a rectangular housing including an upper plate 1 (first plate), a lower plate 51 (second plate) and the side walls 48a, 48b. The upper plate 1 having the fluid inlet 13 may be placed on an upper stream side with respect to the flow direction of the fluid. The fluid outlet 36 may be formed in one of the side walls 48a, 48b. The upper and lower plates 1, 51, and the side walls 48a, 48b may be made from a polymer such as polyethylene, polypropylene, polysulfone, polyethersulfone, polycarbonate, and polyether ether ketone in certain embodiments, and suitable other materials may be used in accordance with the target uses and purposes. The polymer exemplified above can be used for all other components of the housing 15, and suitable different materials can be used in combination.

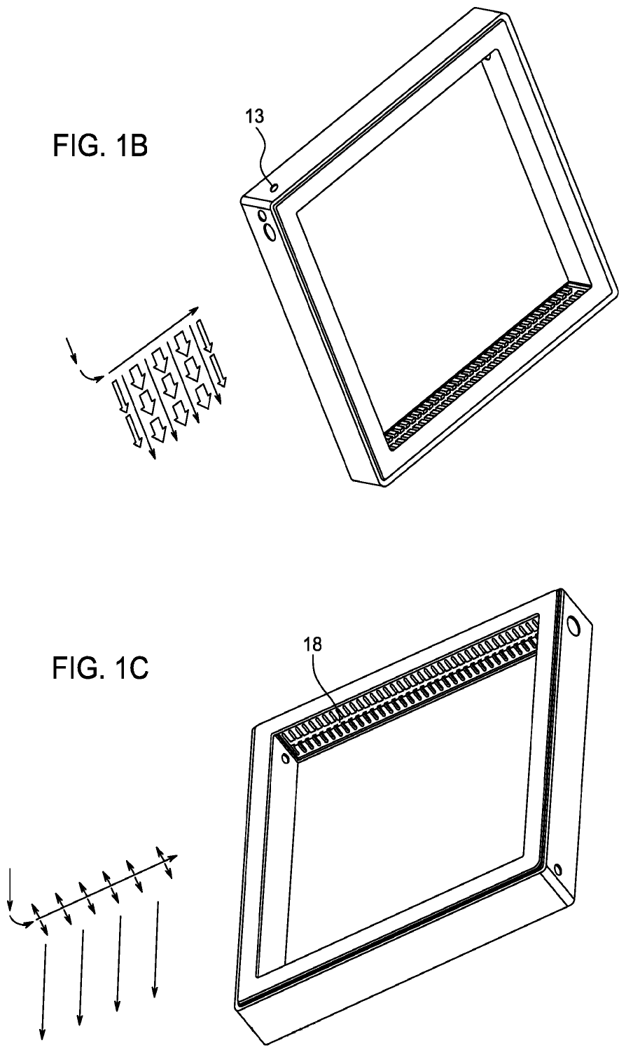

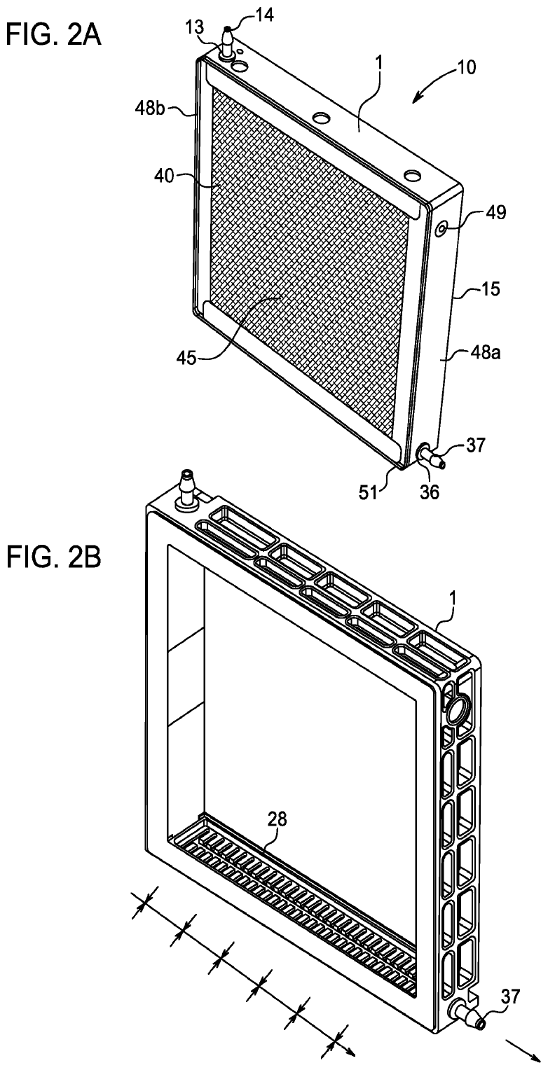

In an embodiment, the inlet frit plate 25 has a plate shape that can be fit to the opening formed in the inlet distribution plate 18, and the outlet frit plate 35 also has a plate shape that can be fit to the opening formed in the outlet distribution plate 28 (see FIG. 3A). Also, the side walls 48a, 48b may be formed to have a structure such that the inlet distribution plate 18 (with the inlet frit plate 25) and the outlet distribution plate 28 (with the outlet frit plate 35) can be inserted and positioned at secure positions inside the housing 15 (see FIG. 1A). Also, the inlet distribution plate 18 and the outlet distribution plate 28 may be formed as an integral part of the housing 15 and to have a structure such that the inlet frit plate 25 and the outlet frit plate 35 can be inserted and positioned at secure positions as shown in FIG. 2A. The inlet frit plate 25 or the outlet frit plate 35 can be bonded to the side walls 48a, 48b using, for example, ultrasonic welding, an adhesive, a solvent bonding, or a mechanical seal.

Positioned in the center portion may be one or more multi-planar screens which may be stacked together as a chromatographic media support structure 40 and may be packed with chromatographic resin or media (e.g., beads). The beads can be held in place and supported securely by the multi-planar screen(s). In a different embodiment, the inlet frit plate 25, the outlet frit plate 35, and the sidewalls 48a, 48b can be structured to enclose the chromatography medium such that the chromatography medium is held in place (even without a multi-planar screen).

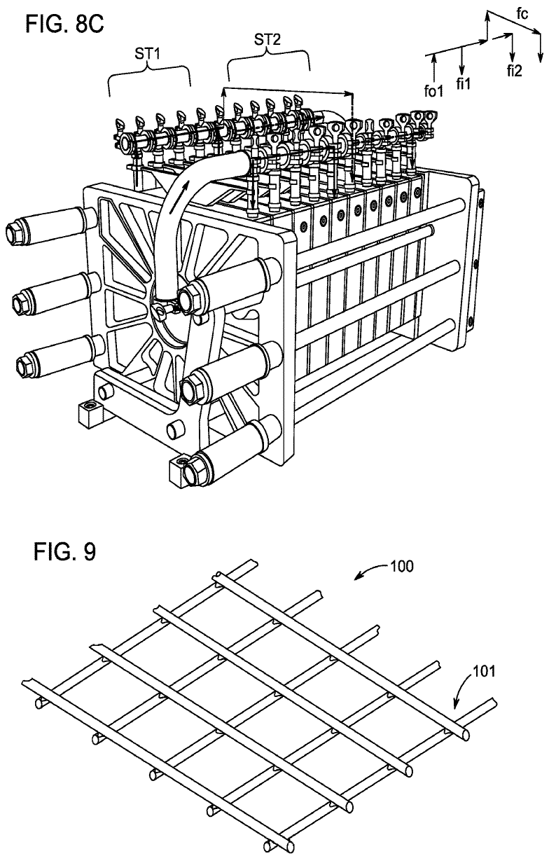

The multi-planar screen(s) in an embodiment is not physically fixed to any parts of the housing 15 (upper plate 1, lower plate 51, side walls 48a, 48b). The parts within the housing 15 can be compressed by the upper plate 1 and the lower plate 51. In an embodiment, more than one multi-planar screens can be laid on each other. The screens can be stacked together and in touch with one another, but do not need to be physically connected or bonded/tied together. For example, the chromatographic media support structure 40 can be formed by multi-planar screens with 2-100 (or more) layers, which may be manufactured by, for example, 3D-printing. The exemplary screens include a bi-planar screen 100 (see FIG. 9) where there are two layered struts 101 forming two planes, and the struts 101 can have an angle of 0-180 degree between the struts 101 of each layer. The struts 101 of the two planes can be attached to each other, for example, by melting. With such structures, an overlap or intermesh between the two struts 101 can be created.

In an embodiment, the multi-planar screen may be a bi-planar screen with a thickness of preferably about 0.1 to 10 mm and more preferably about 0.3 to 3 mm. Such a bi-planar screen may have a strut-to-strut distance of preferably 1 to 50 mm and more preferably about 3 to 10 mm, with the two layers of struts having an angle of preferably about 10° to 170°, more preferably about 30° to 120° and most preferably about 80° to 100°. The intermesh between the two layers of such bi-planar screens may be preferably about 0 to 90 percent of the individual strut height and more preferably about 0 to 50 percent.

The one or more multi-planar screens may be held in place by a front plate 45 and a back plate 47, the inlet frit plate 25, the outlet frit plate 35 and the two side walls 48a, 48b of the housing 15. The arrangement/positioning of the multi-planar screen(s) which can be held in place without physical bonding to any of these parts, as well as the arrangement/positioning of the outlet frit plate 53 inside the housing 15 can affect how the fluid flows and how the force created by the flow is directed to. FIG. 1B shows an embodiment where the fluid that enters through the fluid inlet 13 flows downward, and the drawing illustrates the directions of the flow of the fluid inside the housing 15 and the direction of the force. In an embodiment, the fluid moves in such a downward direction through the inlet distribution plate 18 and inlet frit plate 25 into the chromatographic media, which causes, due to its particle size, a measurable pressure drop in the flow direction, where the pressure is defined as a force per area. Such a pressure drop translates into a force on the chromatographic media, and such force may be further substantially transmitted to the chromatographic media support structure 40 (e.g., multi-planar screen(s)), and the force may then be substantially born by the outlet frit plate 35. As the fluid flows in a downward direction in this embodiment, some of the fluid flows along the side walls 48a, 48b which produce certain force, but the major portion (main portion or substantial portion; more than 50%; possibly more than 90%) of the force created by the flow is born by the outlet frit plate 35 positioned near the bottom of the housing 15 in this embodiment. To measure how much force is born by the outlet frit plate 35, a sensor such as a disc or a foil can be placed on the outlet frit plate 35, and other suitable measurement methods can be employed.

It is recognized that in the present disclosure, there is discussion about flow of fluids and inlets and outlets. In some embodiment as shown by the drawings, the flow may be in a downward direction from the fluid inlet 13 to the fluid outlet 36. The flow, however, in a different embodiment, may be in the opposite direction from what is shown and may be in an upward direction (e.g., pumped) from the fluid outlet 36 towards the fluid inlet 13.

There is additional force/pressure on the device 10 in that the fluid may be pressurized and causes an inner pressure in the housing 15 which is greater than the ambient pressure outside of the housing. Undesired deformation of the sidewalls 48a, 48b may be avoided, for example, by making the thickness of the two side walls 48a, 48b as well as the front plate 45 and back plate 47 sufficiently thick to avoid such deformations. Also, to add rigidity, suitable materials such as a polymer may be selected and formed to have a thickness in a range of 0.1 mm to 100 mm, 1 mm to 60 mm, or 4 to 30 mm]. By adjusting the thickness and/or selecting suitable materials, deformation of the housing 15 may be suppressed without the need to attach or bond the support structure to the side walls or the front and back plate, which is one of the advantages over a conventional device that included a support structure attached to the housing. To facilitate manufacturing of the four side walls of housing 15, it may be advantageous to use a cored-out side wall as shown in FIG. 2B. Such a cored-out structure might contain ribs with a depth of 1 mm-100 mm, or 5-50 mm, and a rib thickness of 0.5 mm-10 mm or 1 mm-5 mm and a rib to rib distance of 1-100 mm or 5-50 mm.

One or several slurry inlet(s) 49 may be included for loading the chromatographic media. The slurry inlet 49 may be on either or both sides on the housing, and in an embodiment may be located in the side walls 48a, 48b. The slurry inlet 49 may be formed in the side walls 48a, 48b such that the direction of supplying chromatographic media into the housing 15 through the slurry inlet 49 is perpendicular to the flow direction. As shown in FIG. 2A, each of the elements may be fitted together to provide a modular chromatographic device 10. FIG. 2B shows the direction of the fluid flow in the outlet frit plate 35 as well as an alternative design for the upper and lower plate 1, 51, and the side walls 48a, 48b with a cored-out side wall as described above (see also FIG. 2A). When appropriate, the outlet distribution plate 28 can be formed integrally with the parts forming the housing 15. In other embodiments, the part of the housing 15 may be constructed separately and assembled together by an available method.

As shown in FIG. 3A, the inlet (and outlet) frit plates 25 (35) may be fit to the respective inlet (and outlet) distribution plate 18 (28). In addition to providing improved flow characteristics, i.e. creating minimal dispersion in the fluid flow, the inlet frit plate 25 and the outlet frit plate 35 can also help retain the resin or media more securely within the housing 15 of the chromatographic device 10.

In some embodiments the inlet and outlet frit plates 25, 35 may be porous and formed from for example, ceramic or polymeric particles having a particle size ranging from 0.1 to 3000 μm, or from 10 to 1000 μm in a certain embodiment. The inlet frit plate 25 can facilitate the flow of the fluid from the inlet distribution plate 18 down into the chromatographic medium. When the inlet frit plate 25 is a porous structure made from a suitable material such as ceramic particles, the use of the inlet frit plate 25 may provide even higher flow rate. The outlet frit plate 35 may also be made porous and also have a desired thickness in view of compressive force that may be applied thereto. Specifically, the major portion of the compressive force caused by the chromatographic medium, particularly when loaded with a slurry of the medium, may be transferred to the outlet frit plates 35. Thus, the inlet and outlet frit plates 25, 35, particularly the outlet frit plate 35 not only may be porous but may also have a desired thickness (such as 0.1 to 10 mm) to bear the forces induced by the flow of the fluids.

The inlet (outlet) distribution plate 18 (28) are placed inside the housing 15 to facilitate fluid distribution and may have a plate form with one or more grooves (channels) formed therein. In an embodiment, the inlet distribution plate 18 (or the outlet distribution plate 28) may have one or more first channels formed in a first direction and one or more second channels formed in a second direction perpendicular to the first direction and connected to the first channel(s).

The first channel(s) may be formed to extend in the direction same as the direction of the inlet distribution plate 18 (or the outlet distribution plate 28) being extended, and multiple second channels may be formed perpendicularly or diagonally to direct and guide the fluid to the first channel(s).

FIGS. 3A-3C show exemplary patterns that can be provided in the inlet distribution plate 18 and the outlet distribution plate 28. In FIG. 3B one or more first channels C1 are extended in the first direction (length direction of flow path f1; D1 in the drawing), and the multiple second channels C2 are formed in the second (width) direction (D2 in the drawing) to provide flow paths f2a and f2b. In FIGS. 3A and 3B, D1 is perpendicular to the D2 direction. The first channel(s) C1 may be formed in a portion toward a central portion of the inlet (outlet) distribution plate 18 (28) and connected to an opening 27 formed on a side portion thereof (see FIG. 3A). The second channels C2 may have a desired spacing (S in FIG. 3B) in between (in the length direction of the flow path), for example, 0.5 to 100 mm in an embodiment or 1 to 10 mm in another embodiment. Alternative patterns may be to have one or more first channels C1 with the second channels C2 branching from the first channel(s) at approximately 45° angles as shown in FIG. 3C. Such a pattern may be referred to as a fishbone pattern. The patterns are not limited to those shown in the drawings, and the inlet and outlet distribution plates 18, 28 may have a desired pattern that can provide advantageous effects for the intended use, for example, maintaining the volume of the entire fluid distribution path as low as possible or maintaining a lower pressure drop. The angle formed by the first and second channels is not limited to 90° or 45°, and the angles may be varied and adjusted to any appropriate angle in accordance with the target effects. With such inlet/outlet distribution plates 18, 28 having desired patterns, effects advantageous for purification can be obtained. For example, a lower pressure drop and a lower hold up volume are advantageous in purification to allow high flow rates and minimal buffer consumption. The inlet distribution plate 18 also may prevent a “jet” of liquid hitting the inlet frit plate 25. A “jet” of liquid is that the fluid moment in the flow direction prohibits an equal flow distribution in the inlet distribution plate and the inlet frit plate. When a jet of liquid occurs, the liquid may flow in one direction with a significantly greater fluid moment as compared to that in another direction, and the liquid may not flow in a balanced, equal distribution. Overall, the designs can be selected to maintain the flow path length substantially the same for every molecule in the fluid.

The inlet (outlet) frit plate 25(35) and the inlet (outlet) distribution plate 18 (28) may be bonded or connected together. For example, the plates may be bonded together using solvent bonding, or other methods of bonding available to those skilled in the art and suitable for the intended use, such as ultrasonic binding, thermal binding and the like.

In some embodiments, the fluid to be separated may pass into the housing 15 through the inlet fitting 14, the inlet distribution plate 18, inlet frit plate 25 and out via the outlet fitting 37. The fluid may flow, after leaving the inlet frit plate 25, in a downward direction through the chromatography packing media, to the outlet frit plate 35, and to the fluid outlet 36.

The chromatographic medium may be a wide variety of resins and constructions depending on what components are being separated from which fluid or liquid. Examples of fluid and the components to be purified include proteins, antibodies, enzymes, DNA or RNA fragments, plasmids and various biomolecules. For example, one may pack the housing with Amsphere® A3 Protein A resin for purification of monoclonal antibodies. Other resins include Capto®Q, Fractogel®, EMD® TMAE, MabSelect®Sure, MacroCap®SP, Q Sepharose® and Toyopearl®.

In some embodiments, the multi-planar screens may hold the resin or media in place. The multi-planar screens can function as a scaffold for the resin or media, and are not attached or fixed to the housing 15, in particular, not to the side walls 48a, 48b of the housing 15, the end plate 45 or the bottom plate 47 of the housing 15. The multi-planar screens can be detachably placed inside the housing 15. In an embodiment, the multi-planar screen may be a series of stacked bi-planar screens that hold the chromatograph media in place, and the screens may be positioned to touch all four walls of the housing 15. Stated otherwise, the multi-planar screens may provide a support structure for the medium. The inlet frit plate 25, the outlet frit plate 35, and the sidewalls 48a, 48b may be structured to enclose the chromatography medium such that the chromatography medium is held in place. In an embodiment, the multi-planar screens may be molded, extruded or three dimensionally printed as a unitary body. In another embodiment, the medium may be provided in a chromatographic bed insert (not shown). In yet another embodiment, the housing 15 itself may be structured to function as a support structure.

The resin or media may be packed into the housing 15 using a combination of, among other things, shaking, vibration, ultra-sonic waves, pressure, up flow and downflow conditioning, optimization of the slurry concentration and/or optimization of the packing buffer of the resin or media. The screens and the resin or media may be held in place by compressive forces provided by the inlet/outlet distribution plates 18, 28, inlet/outlet frit plates 25, 35 and the side walls 48a, 48b. The screens and the resin being pressed by the inlet/outlet distribution plates 18, 28, inlet/outlet frit plates 25, 35, and the side walls 48a, 48b can be securely positioned inside the housing 15 without an additional support structure. The compressive force applied to the multi-planer screens during assembly may preferably be at least about 1 Newton, more preferably at least about 10 Newtons, and most preferably, at least about 100 Newtons.

In an embodiment, flow of the fluid through the device 10 may be reversed and flow from bottom to top namely, from the lower portion of the device to the upper portion. Specifically, in the structure shown in FIG. 2A, the fluid can enter the housing 15 through the opening formed in the side wall 48a (e.g., the fluid outlet 36 above), and the fluid may leave the housing 15 through the opening, e.g., the fluid inlet 13 above. In this configuration, the chromatographic medium may be rinsed with a cleaning agent like sodium hydroxide and after re-equilibration potentially re-used

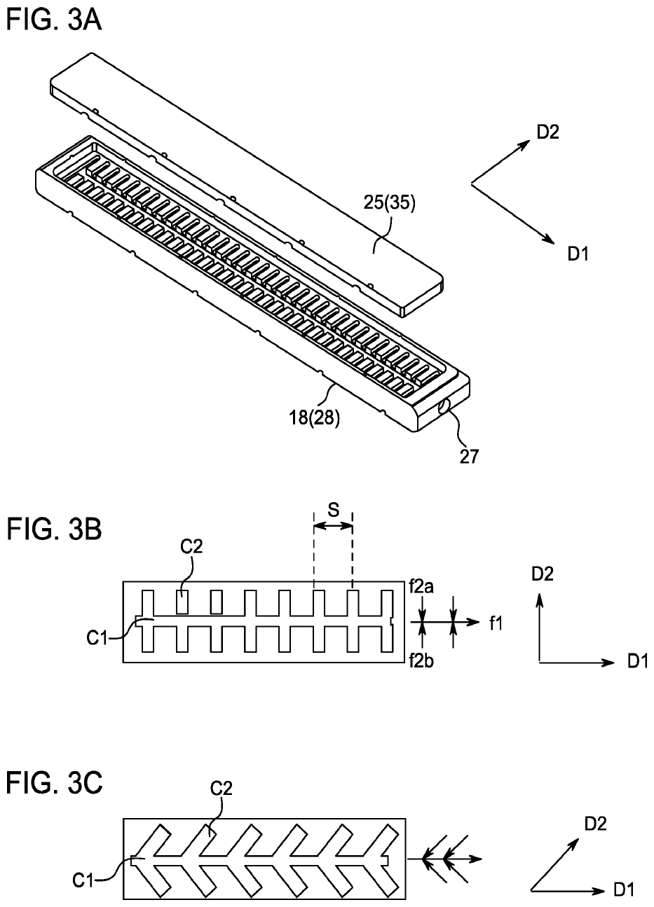

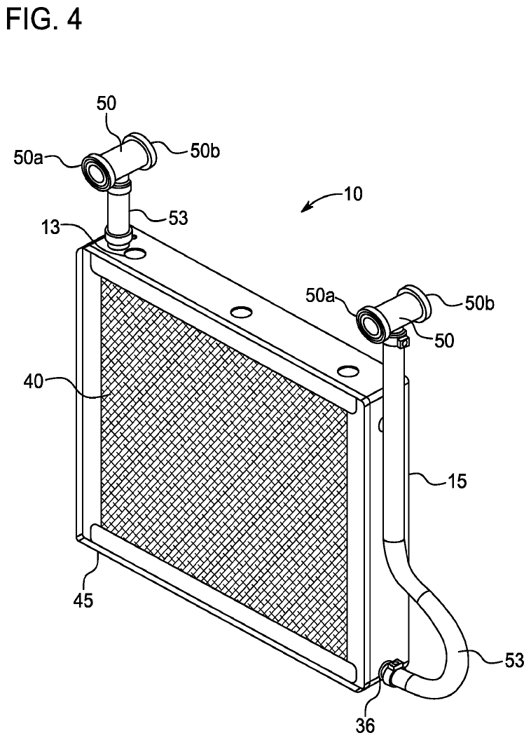

Referring to FIG. 4 and FIG. 5A, liquid may flow into the housing 15 via the fluid inlet 13 and out via the fluid outlet 36. External to the housing may be connectors 50 and tubing 53 which enable multiple chromatography devices to be connected to form a linked series of devices. In an embodiment, the connectors 50 may be a T-shaped fitting and brackets 60 which may be utilized to connect adjacent chromatographic devices. Typically, the overall length of the straight horizontal portion of the T-shaped fitting/connector maybe about 10 to 500 mm. In an embodiment, the overall length of the horizontal portion may be sized to approximately match the overall width of the device so that n devices stacked may have the same or substantially the same length as n connected T-shaped fittings/connectors. FIG. 5B shows an example where an alternative housing design is employed.

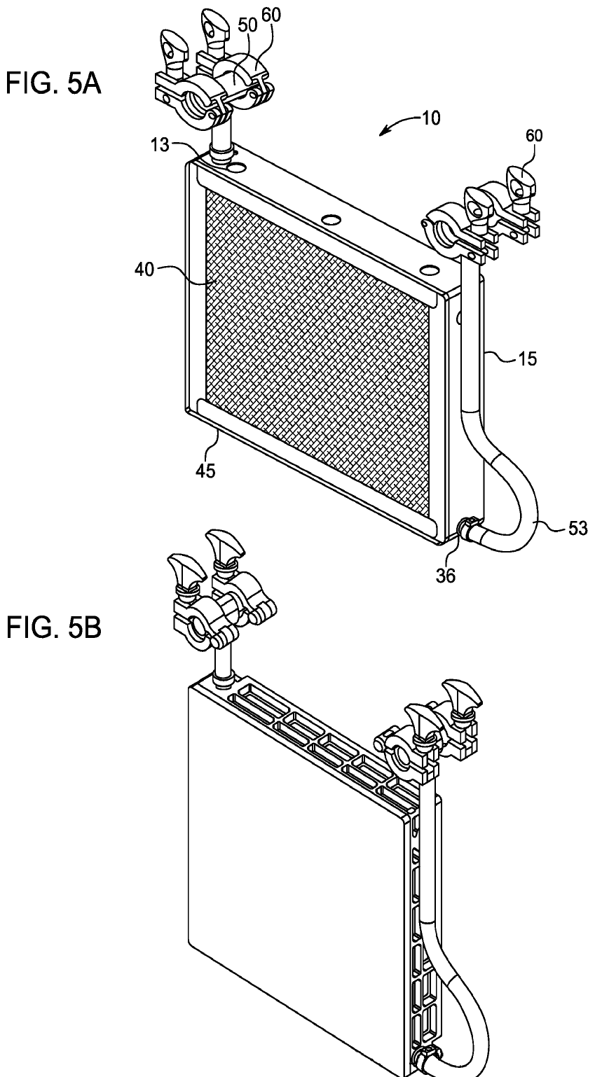

As shown in FIG. 6, the bracket 60 may be configured on each end of the T-shaped connector 50 so that the outlet 65 of one T-shaped connector 50a may be positioned flush and in fluid communication with the inlet 66 of a second T-shaped connector 50b with a gasket 70 positioned between the first and second T-shaped connectors 50a, 50b. The connectors 50 and may have an inner diameter that may be adjusted according to the number of chromatographic devices placed in series. The connectors 50a, 50b may be made from, for example, polyethylene, polypropylene, polysulfone, polyethersulfone, polycarbonate, and polyether ether ketone and may have suitable structures in accordance with the target uses and purposes.

One of the advantages of the chromatographic device 10 of the present disclosure is that multiple chromatographic devices 10 may be connected as a series of devices or modules as shown in FIGS. 7 and 8A-8C and mounted in a holder (e.g., holder 80 in FIG. 8A) to provide a chromatography system 90. Referring to FIGS. 7 and 8B, an inlet supply hose 93 is connected to one end portion of a first chromatographic device 10, and a portion of the fluid supplied through the inlet supply hose 93 enters the first chromatographic device 10 through the fluid inlet 13 (see the flow direction shown by the arrow fi), and leaves the first chromatographic device 10 on the other end portion through the fluid outlet 36 and the tubing 53 (see FIGS. 7, 8B and 2A and the flow direction shown by the arrow fo). The fluid travels through the connectors 50 (see FIGS. 5 and 7 and the flow direction shown by the arrow fd) and enters the second chromatographic device 10 through the fluid inlet 13, and leaves the second chromatographic device 10 through the fluid outlet 36 and the tubing 53, and the fluid flows serially through the remaining ones. The multiple chromatographic devices 10 may be structured so that the fluid is divided substantially in equal portions and flows in a substantially parallel manner through the chromatographic devices 10. The fluid portions that left the chromatographic devices 10 exits via the outlet hose 95. The multiple chromatographic devices 10 may be positioned in a holder 80 and arranged in series. The holder 80 may be a rigid housing, for example, made of stainless steel or fiber-glass filled polymers like polypropylene and structured to hold multiple chromatographic devices 10, for example, 2 to 50 or more of the chromatographic devices 10 in one system 90.

FIG. 8C shows the example where five of the chromatographic devices 10 are placed in parallel in a first stack ST1 and another five of the chromatographic devices 10 are placed in parallel in a second stack ST2 such that the outlet of the first stack ST1 is the inlet of the second stack ST2. The directions of the flows of a liquid/fluid are shown by the arrows in FIG. 8C. The arrow fi1 shows the direction of the flows that go into the chromatographic devices 10 in the first stack ST1 on the right side of the drawing, and the arrow fo1 shows the direction of the flows that come out of the chromatographic devices 10 in the first stack ST1 on the left side of the drawing. The arrow fc shows the flows when the fluid leaves the outlet of the first stack ST1, enters the inlet of the second stack ST2, and flows into the chromatographic devices 10 in the second stack ST2 in the direction of the arrow fi2. The fluid leaves the outlet of the second stack ST2 from the outlet hose 95 (see FIG. 8B).

By structuring the chromatography system 90 as such and circulating the flows through multiple chromatography devices 10, more effective and efficient separation of components in the fluid can be achieved.

The number of the chromatographic devices 10 in one stack can be varied according to the intended use of the chromatography system 90, and the first and second stacks ST1 and ST2 may have different number of the chromatographic devices 10. Such a holder 80 can provide support and prevent deflection of the side walls 48a, 48b. In an embodiment (see FIGS. 7 and 8A-8C), the chromatographic device 10a may be mounted in a serial configuration, with the outlet 65 of a T-shaped connector 50a of the tubing 53 being fluidly connected to the inlet 66 of a T-shaped connector 50b of the tubing 53 of a chromatographic device 10. Furthermore, a first single chromatographic device or a first stack of at least two chromatographic devices connected in parallel may be connected in series to a second chromatographic device or a stack of at least two chromatographic devices. In this embodiment, a steel plate or other devices may be present in between the chromatographic devices or stacks of the chromatographic devices if the pressure drop in adjacent chromatographic devices is different. For example, a steel plate may be placed between the chromatographic devices 10. Another steel plate or other devices may be placed between the first stack ST1 and the second stack ST2. Such plates or devices could mitigate the effect of a pressure drop in one device/stack on another adjacent device/stack.

According to an aspect of the present invention, a chromatographic device includes a housing including an inlet and an outlet of a fluid, an inlet distribution plate positioned inside the housing such that the inlet distribution plate receives the fluid flowing through the inlet and distributes a flow inside the housing, an inlet frit plate positioned on the inlet distribution plate, a chromatography medium placed inside the housing, at least one multi-planar screen positioned inside the housing to receive the fluid to be separated from the inlet distribution plate and the inlet frit plate, the multi-planar screen being structured such that the chromatography medium is held inside thereof, and that the fluid to be separated from the inlet distribution plate and the inlet frit plate passes through the chromatography medium, an outlet distribution plate that receives the fluid separated, and an outlet frit plate positioned on the outlet distribution plate such that the outlet frit plate receives a force created by the fluid through the chromatography medium.

In an embodiment of the chromatographic device, the inlet distribution plate and the inlet frit plate and the outlet distribution plate and the inlet frit plate, are bonded together by a process selected from the group consisting of solvent bonding, ultrasonic bonding and thermal bonding.

In an embodiment, the housing further includes at least one slurry inlet for supplying the chromatography medium.

In an embodiment, the multi-planar screen includes at least one bi-planar screen.

In an embodiment, the chromatography medium comprises a plurality of adsorption beads.

In an embodiment, the inlet distribution plate and the outlet distribution plate each comprise a patterned channel.

In an embodiment, the patterned channel includes a fishbone pattern.

In an embodiment, a chromatographic system includes plural chromatographic devices.

In an embodiment of the chromatographic system, the housing of one of the chromatographic devices is joined to the housing of another of the chromatographic devices at respective inlets and outlets.

In an embodiment, the chromatographic system further includes a connector that provides connection between the housings joined together.

In an embodiment, the connector includes a T-shaped fitting.

In an embodiment, the T-shaped fitting is equal or substantially equal in length to a thickness of each of the chromatographic devices.

According to an aspect of the present invention, a chromatographic device includes a housing including an inlet of a fluid and an outlet of the fluid and having plural side walls, an inlet distribution plate positioned inside the housing, an inlet frit plate positioned on the inlet distribution plate and structured to distribute flow of the fluid, a chromatography medium supported in the housing and positioned to receive the fluid to be separated from the inlet distribution plate and the inlet frit plate, and an outlet distribution plate positioned inside the housing and structured to direct the fluid to the outlet, and an outlet frit plate positioned on the outlet distribution plate to receive a force of a flow of the fluid through the chromatography medium. The inlet frit plate, the outlet frit plate, and the sidewalls enclose the chromatography medium such that the chromatography medium is held in place.

In an embodiment, the inlet distribution plate and the outlet distribution plate each include a patterned channel including a fishbone pattern.

In an embodiment, the chromatographic device further includes at least one multi-planar screen structured to hold the chromatographic medium.

In an embodiment, the multi-planar screen includes at least one bi-planar screen.

In an embodiment, a chromatographic system includes plural chromatographic devices where the housing of one of the chromatographic devices is joined to the housing of another of the chromatographic devices at respective inlets and outlets.

In an embodiment, the chromatographic system further includes a connector structured to provide connection between the housings joined together.

According to an aspect of the present invention, a method of separating components in a fluid includes supplying a fluid including plural components into a chromatographic device.

In an embodiment, the components include at least one of a protein, an antibody, an enzyme, a virus, a DNA fragment, an RNA fragment, plasmid, and a biomolecule.

Although the present approach has been illustrated and described herein with reference to preferred embodiments and specific examples thereof; it will be readily apparent to those of ordinary skill in the art that other embodiments and examples may perform similar functions and/or achieve like results. By way of example, the chromatographic device described herein is not limited to use with chromatographic media and may be used in any adsorptive media devices. All such equivalent embodiments and examples are within the spirit and scope of the present approach.

### REFERENCE SIGNS LIST

1 upper plate
10 chromatographic device
13 fluid inlet
14 inlet fitting
15 housing
18 inlet distribution plate
25 inlet frit plate
27 opening
28 outlet distribution plate
35 outlet frit plate
36 fluid outlet
37 outlet fitting
40 chromatographic media support structure
45 end plate
47 bottom plate
48a, 48b side walls
49 slurry inlet
50 connector
50a, 50b T-shaped connectors
51 lower plate
53 tubing
60 bracket
65 outlet
66 inlet
70 gasket
80 holder
90 chromatographic device
93 inlet supply hose
95 outlet hose
100 bi-planar screen
101 struts

What is claimed is:

1. A chromatographic device, comprising:
a housing including an inlet of a fluid and an outlet of the fluid;
an inlet distribution plate positioned inside the housing such that the inlet distribution plate receives the fluid flowing through the inlet and distributes a flow inside the housing;
an inlet frit plate positioned on the inlet distribution plate;
a chromatography medium placed inside the housing;
at least one multi-planar screen positioned inside the housing to receive the fluid to be separated from the inlet distribution plate and the inlet frit plate, the multi-planar screen being configured such that the chromatography medium is supported inside thereof, and that the fluid to be separated from the inlet distribution plate and the inlet frit plate passes through the chromatography medium;
an outlet distribution plate configured to receive the fluid separated; and
an outlet frit plate positioned on the outlet distribution plate such that the outlet frit plate receives a force created by the flow of the fluid through the multi-planar screen and the chromatography medium.

2. The chromatographic device of claim 1, wherein the inlet distribution plate and the inlet frit plate and the outlet distribution plate and the inlet frit plate, are bonded together by a process selected from the group consisting of solvent bonding, ultrasonic bonding and thermal bonding.

3. The chromatographic device of claim 1, wherein the housing further includes at least one slurry inlet for supplying the chromatography medium.

4. The chromatographic device of claim 1, wherein the multi-planar screen includes at least one bi-planar screen.

5. The chromatographic device of claim 1, wherein the chromatography medium comprises a plurality of adsorption beads.

6. The chromatographic device of claim 1, wherein the inlet distribution plate and the outlet distribution plate each comprise a patterned channel.

7. The chromatographic device of claim 6, wherein the patterned channel comprises a fishbone pattern.

8. A chromatographic system, comprising:
a plurality of chromatographic devices of claim 1.

9. The chromatographic system of claim 8, wherein the housing of one of the chromatographic devices is joined to the housing of another of the chromatographic devices at respective inlets and outlets.

10. The chromatographic system of claim 9, further comprising:
a connector configured to provide connection between the housings joined together.

11. The chromatographic system of claim 10, wherein the connector comprises a T-shaped fitting.

12. The chromatographic system of claim 11, wherein the T-shaped fitting is equal or substantially equal in length to a thickness of each of the chromatographic devices.

13. A chromatographic device, comprising:
a housing including an inlet of a fluid and an outlet of the fluid and having a plurality of side walls;
an inlet distribution plate positioned inside the housing;
an inlet frit plate positioned on the inlet distribution plate and configured to distribute a flow of the fluid;
a chromatography medium supported in the housing and positioned to receive the fluid to be separated from the inlet distribution plate and the inlet frit plate; and
an outlet distribution plate positioned inside the housing and configured to direct the fluid to the outlet; and
an outlet frit plate positioned on the outlet distribution plate to receive a force of a flow of the fluid through the chromatography medium,
wherein the inlet frit plate, the outlet frit plate, and the sidewalls enclose the chromatography medium such that the chromatography medium is held in place.

14. The chromatographic device of claim 13, wherein the inlet distribution plate and the outlet distribution plate each comprise a patterned channel comprising a fishbone pattern.

15. The chromatographic device of claim 13, further comprising:
at least one multi-planar screen configured to hold the chromatographic medium.

16. The chromatographic device of claim 15, wherein the multi-planar screen comprises at least one bi-planar screen.

17. A chromatographic system, comprising:
a plurality of chromatographic devices of claim 13,
wherein the housing of one of the chromatographic devices is joined to the housing of another of the chromatographic devices at respective inlets and outlets.

18. The chromatographic system of claim 17, further comprising:
a connector configured to provide connection between the housings joined together.

19. A method of separating components in a fluid, comprising:
supplying a fluid including a plurality of components into the chromatographic device of claim 1.

20. The method of claim 19, wherein the components include at least one of a protein, an antibody, an enzyme, a virus, a DNA fragment, an RNA fragment, plasmid, and a biomolecule.
